(19) United States
(12) Patent Application Publication
(10) Pub. No.: US 2025/0131266 A1
(43) Pub. Date: Apr. 24, 2025

(54) METHOD FOR IMPACT ANALYSIS OF CHANGING GPT MODELS AND PROMPTS OF A GENERATIVE PRE-TRAINED TRANSFORMER (GPT) PROCESS

(71) Applicant: DELINEA INC., San Francisco, CA (US)

(72) Inventors: Bob JANSSEN, Kralendijk, Bonaire (NL); Peter Gerardus JANSEN, Goirle (NL); Clifford VAN SLIMMING, Almere (NL)

(21) Appl. No.: 18/920,759

(22) Filed: Oct. 18, 2024

Related U.S. Application Data
(60) Provisional application No. 63/592,035, filed on Oct. 20, 2023.

(51) Int. Cl. G06N 3/08; G06N 3/045

(52) U.S. Cl. CPC G06N 3/08; G06N 3/045

(57) ABSTRACT

A method for improving the testability of any system using a GPT model to generate text or other content. The method operates by receiving user requests from the GPT model and a test GPT model and generating answers to the user requests from the GPT model and the test GPT model. After the answers are generated, comparing the generated answers using a GPT model to perform such comparing, then generating metadata from the comparing. Using the generated metadata, score the GPT model and the test GPT model. Then repeat the receiving, generation, comparing and scoring a number of times using different user requests. After repeating the number of times, determine whether the score of the test GPT model is higher than the score of the GPT model. If the test GPT model has a higher score than the GPT model, replace the GPT model with the test GPT model.

### BACKGROUND OF THE INVENTION

The terms “large language model” (LLM) and “Generative Pre-trained Transformer” (GPT) refer to different, albeit related, concepts within the domain of natural language processing (NLP) and machine learning.

Large Language Model (LLM) is a generic term for any language model that has a large number of parameters, typically in the billions or even trillions. LLMs are capable of understanding and generating human-like text. They are trained on vast amounts of text data to learn patterns in language.

Generative Pre-trained Transformer (GPT): This refers to a specific family of LLMs developed by OpenAI, an artificial intelligence research organization. GPT models are based on what is referred to as a Transformer architecture, which is particularly effective for handling sequential data like text. The “pre-trained” part implies that these models are initially trained on a large corpus of text, and can be fine-tuned for specific tasks later.

Scale: Both LLMs and GPT models can be very large in terms of the number of parameters, but GPT models, especially the latest versions like GPT-3 and GPT-4, are some of the largest LLMs to date.

Architecture: LLMs can be built using various architectures including recurrent neural networks (RNNs), convolutional neural networks (CNNs), or the Transformer architecture.

GPT models specifically use the Transformer architecture.

Training Methodology: LLMs can be trained using various methodologies, and may or may not be pre-trained on existing text data. GPT models are trained in two steps: pre-training on a large corpus of text, and fine-tuning on a smaller, task-specific dataset.

### Applications

LLMs, depending on their architecture and training, can be used for a wide range of neuro-linguistic programming (NLP) tasks such as translation, summarization, question-answering, and more.

GPT models, due to their generative nature and scale, are highly versatile and can be used for a similarly wide range of NLP tasks, often achieving state-of-the-art performance. In essence, while all GPT models are large language models, not all large language models are GPT models. The term GPT refers to a specific series of models with a particular architecture and training methodology, whereas the term LLM is more general and can refer to any large scale model capable of processing natural language.

The rapid development and deployment of GPT-based generative models, such as those used in conversational AI systems, often necessitate updates to models, system prompts, or both to improve performance, reliability, and accuracy. However, a key challenge arises when testing these changes due to the inherent non-deterministic nature of GPT-based processes. Even slight variations in model versions, prompts, or configurations can lead to significantly different outcomes, making it difficult to directly compare results from an updated system with those of a previous version.

Traditional methods of regression testing in software rely on deterministic outputs to verify that changes do not introduce unintended consequences. However, in the case of generative models, this approach is impractical since exact replication of outcomes is often impossible. Further complicating this issue is the regulatory constraint that prohibits the storage of customer data, such as sets of user questions and interactions, for testing purposes. This limits the ability to retain historical data for comparison between versions of a model.

As a further example of prior art techniques for comparing two GPT models to determine whether a new/test GPT model provides better results compared to a current production model, a structured evaluation process can be used with the following steps and considerations:

### Define Evaluation Criteria

### Benchmarking

Use a set of standardized benchmarks and datasets relevant to each use case. These should include tasks that test various capabilities, such as text understanding, generation, summarization, and more.

Compare the performance of both models on these tasks using metrics like Bilingual Evaluation Understudy (BLEU), Recall-Oriented Understudy for Gisting Evaluation (ROUGE), or F1-score.

### A/B Testing

Conduct live A/B tests with real users, where half interact with the current model and the other half with the test model. Collect feedback and usage data to assess which model performs better in practical scenarios.

### Human Evaluation

Organize assessments where human evaluators rate responses from both models based on predefined criteria. This can include blind testing where evaluators do not know which model produced the response.

### Error Analysis

Analyze the types and frequencies of errors made by both models. This helps understand specific weaknesses and strengths.

### Performance and Efficiency

Compare computational efficiency, such as response time and resource usage, to ensure the new model doesn't compromise performance.

By combining quantitative metrics with qualitative feedback and real-world testing, one can comprehensively assess whether the new model provides better results. However, these techniques can be time consuming and do not always provide accurate results.

### SUMMARY OF THE INVENTION

The invention addresses these challenges by introducing a novel testing mechanism for GPT generative processes. The mechanism operates in parallel with an existing model, using the new version of the model to generate outcomes that are then compared to those produced by the current system. Critically, the comparison itself is facilitated by a GPT-based evaluation process, which assesses the differences between the outputs and only stores metadata about the comparison, thus ensuring compliance with data privacy regulations. Based on the analysis of these outcomes, a performance score is generated that helps determine whether the new model should be deployed in a production environment. This innovative process ensures more effective and compliant testing, enabling safer and more reliable model updates.

### BRIEF DESCRIPTION OF THE DRAWINGS

FIG. 1 is a flow diagram showing the steps employed to implement the invention.

### DETAILED DESCRIPTION OF THE INVENTION

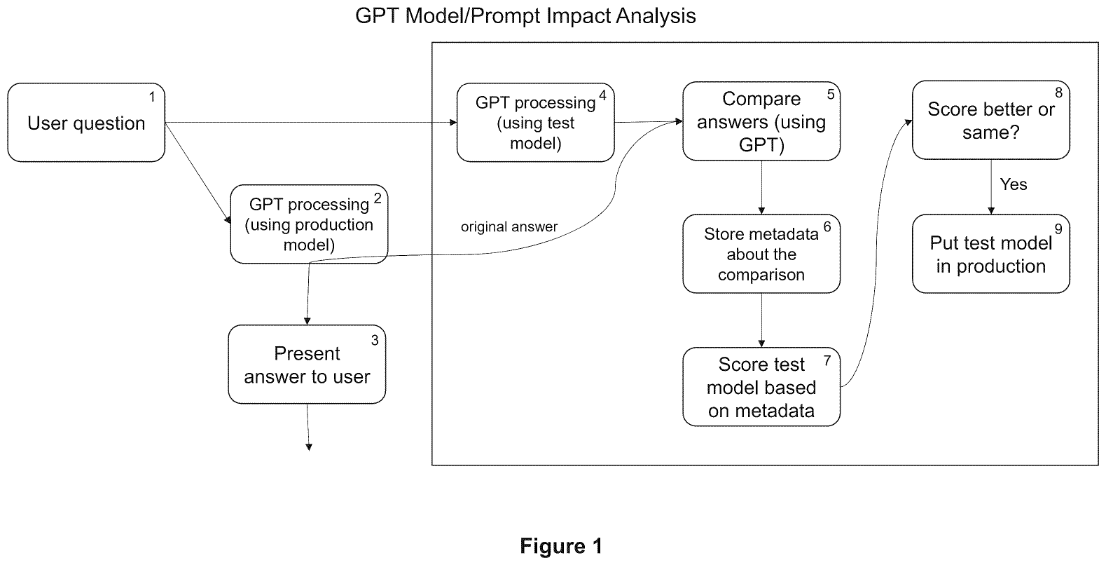

As shown in FIG. 1, the process starts 1 with a user asking a question also known as a prompt (in case of a chatbot) or any other GPT request as in the prior art.

Regular processing 2 takes place to answer the user question (or process the request) using the current production GPT model as in the prior art.

The generated outcome of this request is provided 3 to the user as text as in the prior art.

In parallel, the same question (or other GPT request) is also processed 4 using a new model that is being tested and the outcome from the new model is provided as text.

When both outcomes are available, they are compared 5 using a GPT model which has been pre-trained and is provided with prompts to fine-tune the model to enable it to compare answers to make sure the outcome coming from the new model is at least as good (or better) than the outcome from the existing (production) model.

Metadata of these outcomes, their compared performance and accuracy are stored 6 for later use. The actual question or request and answer are not stored for privacy reasons.

A score is calculated 7 for a number of requests or for a period of time to compare the new model against the existing model.

This score is then used 8 to determine if the performance/accuracy of the new model is at least as good as (or better than) the existing model.

If the new model scores at least as good or better than the existing model, then the new model is used as the production model, and the original model is made unavailable for production use.

The exact criteria for the comparisons are determined by the prompts that are provided to the GPT for this comparison. The more strict/precise the prompts, the more strict/precise the comparison. A basic prompt at step 5 can be: “Given a user question ‘xxx’ compare the two answers below and determine which one is better: ‘<answer 1>OR<answer 2>’”. Depending on specific requirements, this prompt can be more elaborate or more specific on what to compare. Also, the GPT can be configured to return a confidence score on its outcome, which can be used to determine how sure it is on its comparison of the answers. Also, the GPT can be prompted to, besides outputting if the new answer is worse/same/better, also provide the reasoning it used to determine this outcome. One has to consider here though, that this reasoning can contain parts of the answers, which can be a privacy concern.

In case of a Retrieval Augmented Generation (RAG) system, where external data is provided to the GPT model, the data that is referenced (in case of RAG) in the answers can be compared to make sure it is at least referencing the expected sources in the test answer. The result of this comparison of referenced data can also be part of the metadata.

Metadata stored in step 6 is produced by step 5, which compares the two answers/outcomes. Metadata consists of the production and test models and versions used, which model was used for the comparison, the confidence score on the comparison outcome, the result of comparing data sources that were referenced etc. Because of privacy concerns, this metadata should not contain the original user question or answers from both models.

By way of example, using the question: What is the capital of France?

Possible answer 1 (from production model): The capital of France is Paris

| | | |
|---|---|---|
| Metadata: | Number of input tokens: | 8 |
| | Number of output tokens: | 9 |
| | Time to generate answer: | 1.25 sec |
| | Cost: | $0.04 |

Possible answer 2 (from test model): Paris is the capital of France

| | | |
|---|---|---|
| Metadata: | Number of input tokens: | 8 |
| | Number of output tokens: | 9 |
| | Time to generate answer: | 1.70 sec |
| | Cost: | $0.003 |
| | Compare result: | same |
| | Compare result confidence: | 0.98 |

In this example, the test model obtained the same result, but it took 0.45 seconds longer but at a lower cost. From this, it cannot be said that the test model is “better” but after a series of questions have been provided, a choice of which is better may be clearer.

The confidence score is a probability that is returned by the model for each token (part of a word) in the answer. The GPT model predicts each following token in its output based on the probability of that token being the next. Calculating the “next token probability” is an integral function of a GPT model. It is basically how GPT generates text. Exposing this probability is a “by-product” of the GPT model output. See, for example:
https://huggingface.co/blog/alonsosilva/nexttokenprediction.

The GPT model can be instructed to return these probabilities alongside the actual answer: if the answer contains 10 tokens, it will also contain 10 probability scores (one for each token). In this case the output is only 1 token (worse/same/better), so it will only have one probability score returned, which necessarily is its probability (or confidence) of the output token being what it is.

Step 5 compares a single request against a production and test model, while step 7 calculates a score based on a set of requests (for example over a period of time). The outcome of a comparison of a single request is basically: worse/same/better (optionally with a confidence score on how sure GPT is of this outcome). The score calculated in step 7 is to show how overall, on a set of requests, the test model compares to the production model. It depends on the situation how best to calculate this. For example, to make sure the new model is generally at least as good or better than the old model (but not necessarily better on all individual requests), one could use the following method: for each request calculate ‘same outcome’=0, ‘worse outcome’=−1, ‘better outcome’=+1, where the sum for all requests added up has to be >0 (or >x, where x is a number relative to the number of requests in the set). In a situation where it is critical that the test model scores better on all individual requests, one could simply count the number of requests that have a worse outcome and this score has to be 0 for the test model to pass. At step 8, the scores are compared to determine whether the test model scores better than a current production model. If so, at step 9, the test model can be made the new production model. \

The reason for using a GPT model for comparing outcomes is due to the non-deterministic nature of GPT outcomes (asking the same question multiple times will result in different outcomes) so it is difficult to compare the outcomes of a question from different models in a traditional manner. The text-analysis capabilities of a GPT model are crucial in being able to compare outcomes in a way that is flexible and reliable, while leaving room for differences in exact wording.

By integrating a GPT model into the evaluation process, its natural language processing capabilities is leveraged to enhance efficiency, reduce manual effort, and provide nuanced insights into model performance.

Comparing two outputs (and using a GPT model for this comparison) as a means of testing, largely eliminates the need to define tests beforehand or define assertions on those tests: just comparing the output of a new, “model-under-test” with the output from a production (and therefore trusted) model provides an easy and fast method of testing. It easily and quickly validates that a new “model-under-test” still produces outcomes that are comparable with current outcomes.

Comparing outputs from both a production model and a model-under-test can be done in a production environment by introducing a new step after the normal processing has occurred which generates the answer for the user. This new step does the same processing but using the new “model-under-test” and then triggers the process that compares the outcomes and stores metadata. This metadata can be used to score the new “model-under-test”. This can be done real-time (in a running production environment) and because only the metadata and scores are stored, there are no privacy concerns. Furthermore, there is no need to be concerned with the specific questions or outcomes. The only criteria is how the outcomes compare.

The flow diagram provided in the FIGURE is representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram.

Moreover, not all acts illustrated in a methodology may be required for a novel implementation.

The above description and associated FIGURES teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

We claim:

1. A method for improving the testability of a system using a Generative Pre-trained Transformer (GPT) model to generate text or other content comprising:
receiving user requests from the GPT model and a test GPT model;
generating answers to said requests from said GPT model and said test GPT model;
comparing said generated answers using a GPT model fine tuned to perform said comparing;
generating metadata from said comparing;
scoring said GPT model and said test GPT model based on said generated metadata;
repeating said receiving, generating, comparing and scoring a predetermined number of times using different user requests;
determining whether said score of said test GPT model is higher than said score of said GPT model after said predetermined number of repeating has been completed;
if said test GPT model has a higher score than said GPT model, replacing said GPT model with said test GPT model.

2. The method defined by claim 1 wherein said comparing from said GPT model and said test GPT model uses metadata which includes a number of tokens contained in each user request and each corresponding answer, a time to generate each said corresponding answer and a cost associating with said generating said metadata.

3. The method defined by claim 2 wherein said metadata includes the GPT model and the GPT test models and versions used, which model was used for the comparison, a confidence score on the comparison outcome, the result of comparing data sources that were referenced.

4. The method defined by claim 2 wherein the metadata does not contain the user requests or answers from both models.
